(19) United States
(12) Patent Application Publication
(10) Pub. No.: US 2019/0248327 A1
(43) Pub. Date: Aug. 15, 2019

(54) SMART KEY FOR A VEHICLE AND SMART ELECTRONIC CONTROL SYSTEM INCLUDING THE SAME

(71) Applicant: MKD Technology Inc., Hsinchu City (TW)

(72) Inventor: Ming-Chia HUANG, Hsinchu City (TW)

(21) Appl. No.: 16/032,249

(22) Filed: Jul. 11, 2018

(30) Foreign Application Priority Data
Feb. 14, 2018 (TW) 107105441

(51) Int. Cl. B60R 25/24; G07C 9/00; G06F 3/16

(52) U.S. Cl. CPC B60R 25/24; G07C 9/00309; G07C 2009/0038; G07C 2009/00507; G06F 3/167

(57) ABSTRACT

A smart key is provided for use with a body control module (BCM) of an electronic control unit (ECU) of a vehicle. The BCM is configured to control electronic devices of the vehicle. The smart key includes a transceiver unit to communicate with the ECU, a control unit coupled to the transceiver unit, and a display unit coupled to the control unit. The control unit is configured to establish connection with the ECU via communication between the transceiver unit and the ECU for controlling operation of the BCM, and to control the display unit to display a state of at least one of the electronic devices controlled by the BCM.

### CROSS-REFERENCE TO RELATED APPLICATION

This application claims priority of Taiwanese Invention Patent Application No. 107105441, filed on Feb. 14, 2018.

### FIELD

The disclosure relates to a smart key for a vehicle, and more particularly to a smart key adapted for remotely controlling operation of the vehicle.

### BACKGROUND

In the automobile industry, smart keys are widely used to facilitate users to control operation of vehicles, such as locking/unlocking vehicle doors, releasing a trunk, etc., without using a mechanical key.

Conventional smart keys transmit radio frequency (RF) signals to the vehicle to perform simple control of vehicles, such as door locking/unlocking, trunk releasing, etc., and the available functions thereof are limited.

### SUMMARY

Therefore, an object of the disclosure is to provide a smart key that can remotely control operation of electronic devices of a vehicle, and that can display a state of at least one of the electronic devices in a real time manner.

According to the disclosure, the smart key adapted for use with a body control module (BCM) of an electronic control unit (ECU) for a vehicle is provided. The BCM is configured to control electronic devices of the vehicle and the smart key includes a transceiver unit configured to communicate with the ECU, a control unit coupled to the transceiver unit, and a display unit coupled to the control unit. The control unit is configured to establish connection with the ECU via communication between the transceiver unit and the ECU for controlling operation of the BCM, and to control the display unit to display a state of at least one of the electronic devices controlled by the BCM.

Another object of the disclosure is to provide a smart electronic control system for a vehicle.

According to the disclosure, the smart electronic control system includes an electronic control unit (ECU) and a smart key. The ECU is to be disposed on a vehicle and includes a body control module (BCM) configured to control electronic devices of the vehicle. The smart key includes a transceiver unit configured to communicate with the ECU, a control unit coupled to the transceiver unit, and a display unit coupled to the control unit. The control unit is configured to establish connection with the ECU via communication between the transceiver unit and the ECU for controlling operation of the BCM, and to control the display unit to display a state of at least one of the electronic devices controlled by the BCM.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating an embodiment of a smart electronic control system for a vehicle according to the disclosure;

FIG. 2 is a schematic diagram illustrating a smart key of the embodiment;

FIG. 3 is a schematic diagram illustrating that the smart key displays options under a category of “Security Information”;

FIG. 4 is a schematic diagram illustrating that the smart key displays options under a category of “Vehicle Information”;

FIG. 5 is a schematic diagram illustrating that the smart key displays options under a category of “Air Conditioner Preset”; and

FIG. 6 is a schematic diagram illustrating that the smart key displays options under a category of “Setting”;

FIG. 7 is a schematic diagram illustrating that the smart key displays options under a category of “Registration”.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

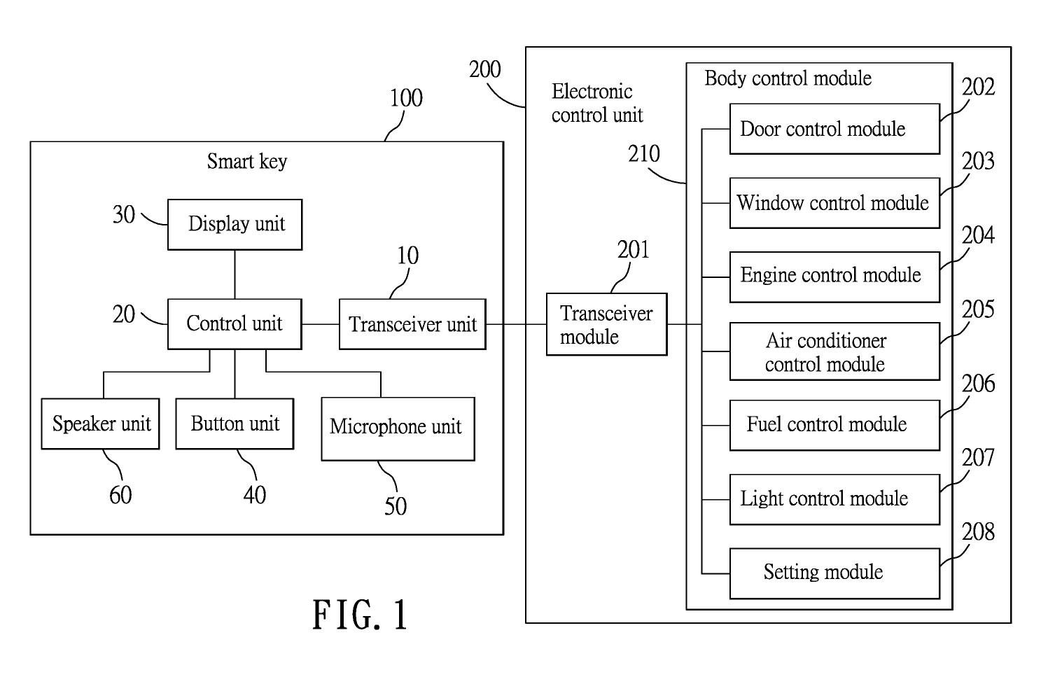

Referring to FIG. 1, the embodiment of the smart electronic control system for a vehicle (not shown) according to this disclosure includes a smart key 100 and an electronic control unit (ECU) 200 that is capable of communication with the smart key 100. The ECU 200 is configured to be installed on the vehicle, which may be a car, an electric motorcycle, etc., and includes a transceiver module 201 configured for communication with the smart key 100, and a body control module (BCM) 210 coupled to the transceiver module 201, and configured to control electronic devices (not shown) of the vehicle, such as an air conditioner, an engine, a lamp device, a speaker device, etc. The smart key 100 is configured to control operation of the BCM 210 and to display a state of at least one of the electronic devices controlled by the BCM 210, thereby achieving smart control. In this embodiment, the ECU 200 includes a controller area network bus (CAN bus) via which the BCM 210 is connected to the electronic devices of the vehicle. In other embodiments, the BCM 210 may be connected to the electronic devices of the vehicle via another interface such a local interconnect network bus (LIN bus), FlexRay, MOST, IDB-1394, Byteflight, etc., and this disclosure is not limited in this respect. In a case that the ECU 200 is installed on a vehicle that has an originally equipped ECU, which may be provided by an original factory that manufactured the vehicle, the BCM 210 may be connected to the electronic devices of the vehicle and acquire authority of controlling the same via an interface (e.g., a CAN bus, a LIN bus, FlexRay, MOST, IDB-1394, Byteflight) of the originally equipped ECU and using a protocol used by the originally equipped ECU.

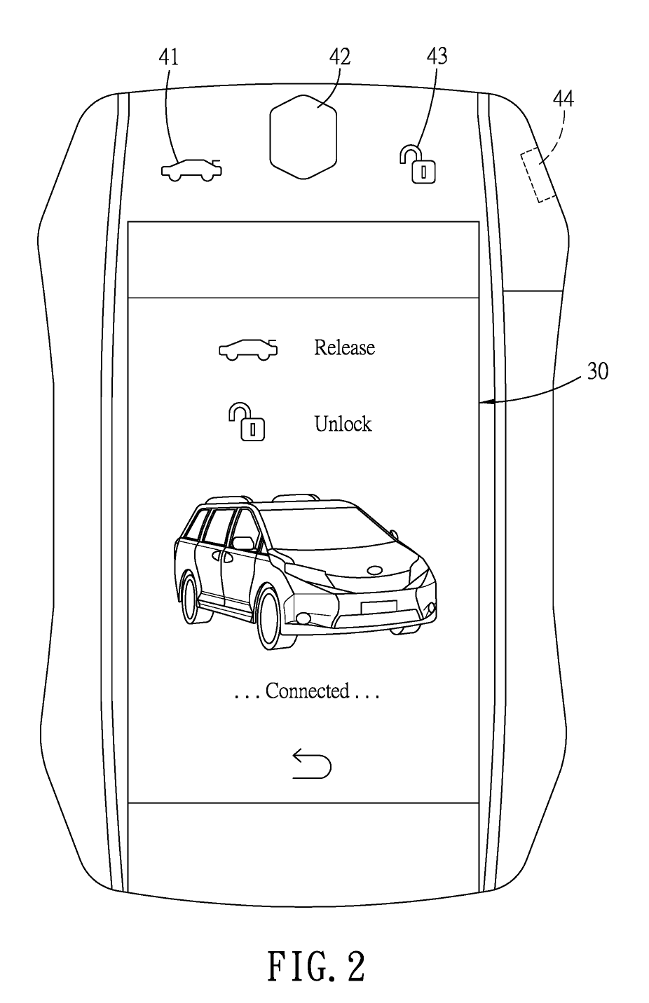

Referring to FIGS. 1 and 2, the smart key 100 includes a transceiver unit 10, a display unit 30, a button unit 40, and a control unit 20 coupled to the abovementioned units 10, 30, 40.

The transceiver unit 10 includes a wireless communication circuit compatible with a wireless communication technology, such as radio frequency identification (RFID), near field communication (NFC), WiFi, Bluetooth, a 3G network, a 4G network, etc., so as to perform communication with the ECU 200 via the transceiver module 201.

The control unit 20 may be a central processing unit (CPU) or a micro control unit (MCU), configured for controlling signal transmission of the units 10, 30, 40, and controlling operation of the BCM 210 of the ECU 200.

The display unit 30 includes a display screen for displaying the states of the electronic devices controlled by the BCM 210. In this embodiment, the display unit 30 is exemplified to include a touch screen capable of touch control, so that the control unit 20 may control operation of the BCM 210 in response to a touch operation on the touch screen.

The button unit 40 includes a trunk control button 41 for releasing a trunk of the vehicle, a lock button 42 for locking at least one door of the vehicle, an unlock button 43 for unlocking at least one door of the vehicle, and a power button 44 for switching the smart key 100 between a power-on state and a power-off state. In this embodiment, the smart key 100 is configured to enter the power-off state when the power button 44 is held down for a predetermined time period (e.g., 3 seconds). In this embodiment, a backlight of the display unit 30 is turned off when the smart key 100 is in the power-off state, so the display unit 30 is unable to display images under this situation.

When a user presses or triggers the button unit 40 to make the button unit 40 generate a trigger signal, or operates the touch screen of the display unit 30 to make the display unit 30 generate a touch control signal, the control unit 20 generates a control signal in response to the trigger signal or the touch control signal, and transmits the control signal to the BCM 210 of the ECU 200 through the transceiver unit 10 and the transceiver module 201, thereby controlling the BCM 210 to perform corresponding operation.

In this embodiment, the BCM 210 includes a door control module 202, a window control module 203, an engine control module 204, an air conditioner control module 205, a fuel control module 206, a light control module 207 and a setting module 208, each of which is coupled to the transceiver module 201.

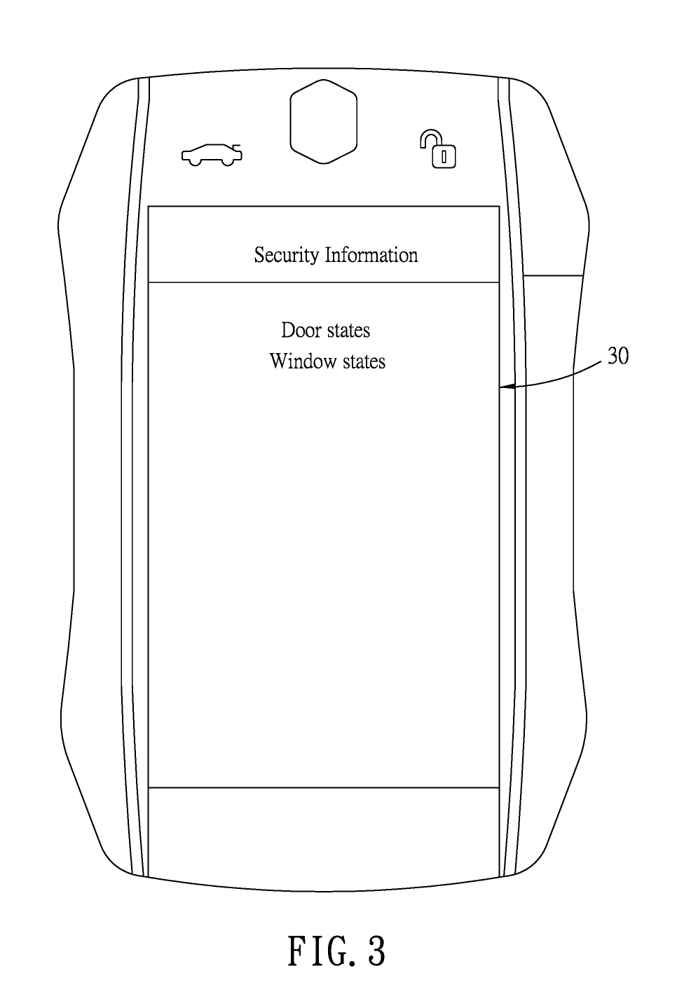

Referring to FIGS. 1 and 3, via communication established between the transceiver unit 10 and the transceiver module 201, the smart key 100 may remotely control operation of the BCM 210, and display the states of the electronic devices that are controlled by the BCM 210 in a real time manner. As exemplified in FIG. 3, the display unit 30 is capable of displaying the states of the doors and the windows of the vehicle. When the user performs touch operation on the touch screen of the display unit 30, the control unit 20 wirelessly transmits the control signal to the door control module 202 or the window control module 204 through the transceiver unit 10 and the transceiver module 201, so that the door control module 202 controls operation of the doors of the vehicle (e.g., switch the doors of the vehicle from a lock state to an unlock state, or from the unlock state to the lock state), or the window control module 203 controls operation of the windows of the vehicle. Simultaneously, the door control module 202 reports the states of the doors (opened or closed) to the control unit 20, or the window control module 203 reports the states of the windows to the control unit 20, so that the control unit 20 is able to control the display unit 30 to display the states of the doors or the windows in a real time manner.

It should be noted that, in this embodiment, the doors of the vehicle, which is exemplified as a car, include one driver door, three passenger doors and a trunk door, and the state displayed for the doors may be one of “Secured”, “Non-secured”, and “Opened”. The “Secured” state represents that all of the doors are closed and locked; the “Non-secured” state represents that at least one of the doors is not closed or is unlocked; and the “Opened” state represents that all of the doors are opened. In this embodiment, the windows of the vehicle include two front side windows, two rear side windows, and a sunroof. The state displayed for the windows may be one of “Closed” and “Non-closed”. The “Closed” state represents that all of the windows are completely closed; and the “Non-closed” state represents that at least one of the windows is not completely closed. The numbers of the doors and the windows, and the display manner may vary in different embodiments, and this disclosure is not limited in this respect.

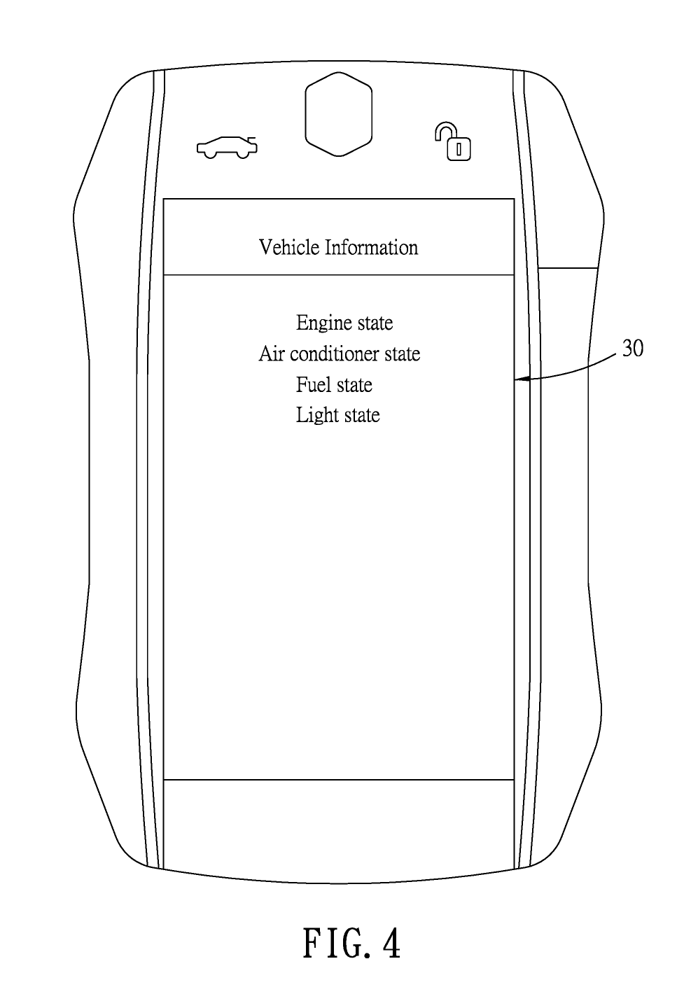

The user may perform touch operation (e.g., a slide operation) on the touch screen of the display unit 30 to change content displayed by the display unit 30. Referring to FIGS. 1 and 4, the display unit 30 may be operated to display a state of the engine, a state of the air conditioner, a state of fuel amount or fuel consumption, a state of lighting, etc. In response to user operation that relates to operation of the engine of the vehicle on the touch screen, the control unit 20 may wirelessly transmit a control signal to the engine control module 204, so that the engine control module 204 controls the engine to start or shut down based on the control signal, and reports a state of the engine to the control unit 20. In response to user operation that relates to operation of the air conditioner of the vehicle on the touch screen, the control unit 20 may wirelessly transmit a control signal to the air conditioner control module 205, so that the air conditioner control module 205 turns on or turns off the air conditioner based on the control signal, and reports a state of the air conditioner to the control unit 20. In response to user operation that relates to monitoring the fuel consumption of the vehicle on the touchscreen, the control unit 20 may wirelessly transmit a control signal to the fuel control module 206, so that the fuel control module 206 controls a fuel gauge to monitor a variation of the fuel based on the control signal, and reports a state of the fuel variation to the control unit 20. In response to user operation that relates to lighting of the vehicle on the touch screen, the control unit 20 may wirelessly transmit a control signal to the light control module 207, so that the light control module 207 turns on or turns off the lamp devices of the vehicle based on the control signal, and reports a state of the lamp devices to the control unit 20. It is noted that what can be displayed by the display unit 30 is not limited to this embodiment. As an example, the display unit 30 may be used to display a variety of information, such as tire pressure, remote diagnosis for a health condition of the vehicle, self diagnosis for the health condition of the vehicle, ECO driving report, maintenance reminder etc., and this disclosure is not limited in this respect.

The state displayed for the engine may be one of “On”, which represents that the engine has been started, and “Off”, which represents that the engine has been shut down. The state displayed for the air conditioner may be one of “ON”, which represents that the air conditioner is in a power-on state, and “Off”, which represents that the air conditioner is in a power-off state. The state displayed for the fuel consumption may represent an amount of gasoline remaining in a fuel tank of the vehicle, which may be detected by the fuel gauge. The lamp devices of the vehicle may include headlamps, internal lamps, etc. The state displayed for lighting may be one of “On” and “Off”, where the “On” state represents that at least one of the lamp devices is in a power-on state, and the “Off” state represents that all of the lamp devices are in a power-off state.

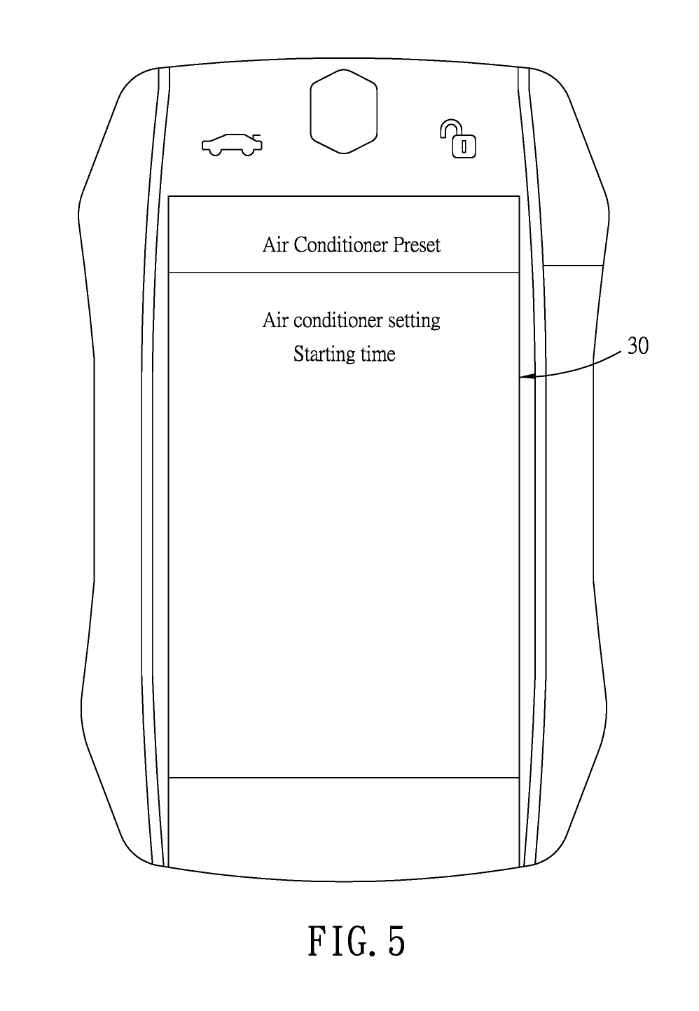

Referring to FIGS. 1 and 5, in this embodiment, the engine and the air conditioner may be automatically turned on or turned off via a presetting function. In one implementation, the user may operate the display unit 30 to set a time at which the engine and the air conditioner are required to be turned on/off, and set a desired temperature for the air conditioner, and the smart key 100 may store the time and temperature settings. When the time has reached the preset time, the control unit 20 transmits a control signal to the BCM 210, so that the engine control module 204 starts the engine, and the air conditioner control module 205 turns on the air conditioner with the temperate setting. As a result, when the user reaches the vehicle, the vehicle will have been warmed up and the temperature inside the vehicle will have been adjusted to a comfortable level.

In one implementation, the user may preset several time points to control on/off operations of the engine, the air conditioner and the lamp devices in a desired sequence. For example, the user may use the presetting function to cause the engine to be started at a first time point (e.g., 8:00 AM), cause the air conditioner to be turned on at a second time point (e.g., 8:05 AM), and cause the lamp devices to be turned on at a third time point (e.g., 8:10 AM). In addition, the air conditioner may be configured to automatically determine an operation mode thereof based on a temperature sensed by a thermometer or a date set in the ECU 200. For example, the air conditioner may output warm air when the date corresponds to winter, and output cold air when the date corresponds to summer.

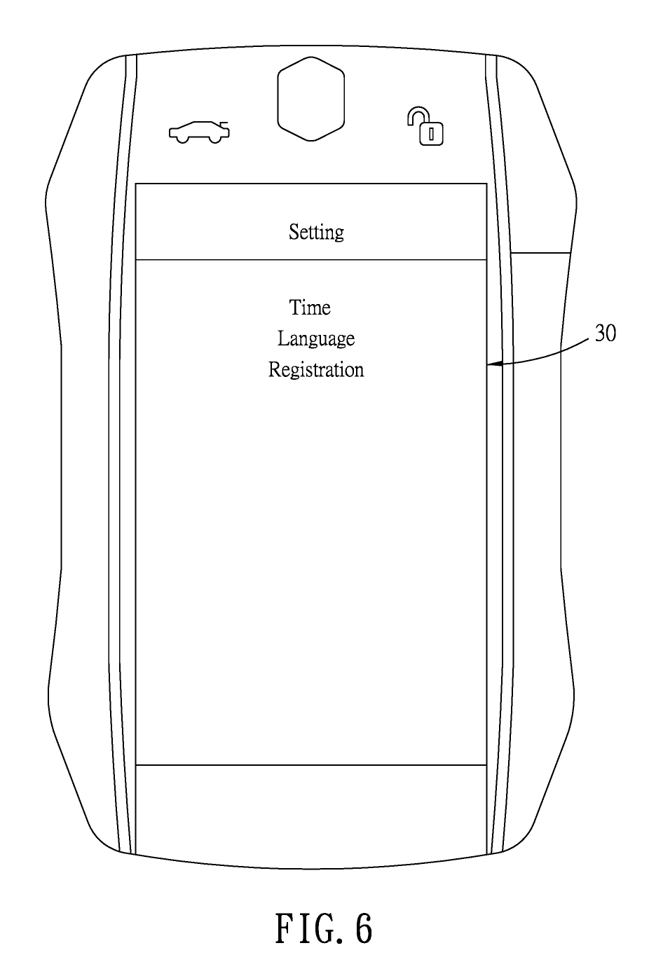

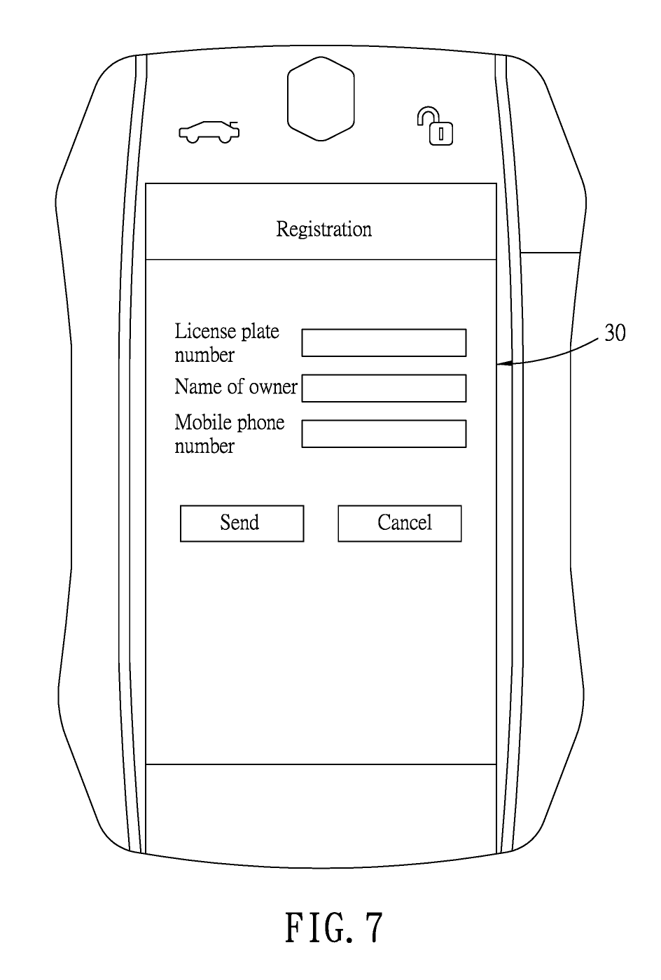

Referring to FIGS. 1 and 6, the user may operate the touch screen of the display unit 30 to make the display unit 30 display messages regarding settings for the ECU 200. The settings are exemplified to include a time setting, a language setting, registration, etc. The time setting allows the user to set current time (e.g., year, month, day, hour, minute and second) for the ECU 200. The language setting allows the user to select a language used by the ECU 200 from several preset language modes (e.g., traditional Chinese, simplified Chinese, Japanese), and the default language may be English. The control unit 20 may wirelessly transmit a control signal to the setting module 208 in response to user operation on the touch screen of the display unit 30. Upon receipt of the control signal, the setting module 208 sets the time and language for the ECU 200, and reports the state of the settings to the control unit 20, so that the display unit 30 may display the state of the current settings of the ECU 200. Further referring to FIG. 7, the registration relates to registering information of, for instance, a registration plate number of the vehicle, a name of the vehicle owner, a phone number of the vehicle owner, an email address of the vehicle owner, etc. The transceiver unit 10 of smart key 100 may be further configured to establish communication with a backend server or a host server of the vehicle vendor, so as to transmit the abovementioned information to the server to link the vehicle to the owner, thereby preventing the vehicle from being used by an unauthorized person. Modification of the abovementioned information may require confirmation via the registered phone number or email address.

By virtue of the communication between the smart key 100 and the ECU 200, the smart key 100 is able to remotely control operation of the BCM 210 of the ECU 200 based on the user's operations and setting, and to display results of the desired operation in a real time manner, promoting convenience of usage.

In some embodiments, the ECU 200 may further include data transfer interface, such as a universal serial bus, for transferring data relating to the smart key 100 and/or driving information of the vehicle to another electronic device. In some embodiments, the BCM 210 may further include a motor control module (not shown) configured for independent control of the sunroof, and control operation of headlights of the vehicle (e.g., when the driver rotates the steering wheel to make a turn, the motor control module may control the headlights to rotate correspondingly, such that the headlights emit light toward a direction that the driver wishes to turn to). The smart electronic control system is applicable to a passive keyless entry (PKE) system, in which the vehicle would automatically unlock the door(s) upon detecting presence of the smart key 100 within a detecting range (e.g., 1.8 meters from the vehicle), and would automatically lock the door(s) and activate an alarm system upon detecting that the smart key 100 is not in the detecting range. Furthermore, the smart electronic control system is applicable to a passive entry passive start (PEPS) system which further enables the engine to be started without insertion of the smart key 100 into the vehicle, achieving smarter security management.

In some embodiments, the transceiver unit 10 is further configured to be capable of establishing communication with a server or a computer of a rescue center, so that the control unit 20 may be operated to issue a message to the rescue center when a traffic accident or an emergency occurs for seeking help. Services that may be provided via the smart key 100 are listed in Table 1, but this disclosure is not limited in this respect.

TABLE 1

| Category | Function |
|---|---|
| Remote control | Remote doorlock |
| | (lock/unlock) |
| | Remote window control |
| | (up/down) |
| | Query of vehicle state |
| | Vehicle finding |
| | (lighting/buzzer) |
| | Remote engine control |
| | (start/shutdown) |
| | Remote air conditioner control |
| | (on/off) |
| Vehicle diagnosis | Remote diagnosis |
| | Self diagnosis |
| | ECO driving report |
| | Display of door/hood/trunk |
| | state (opened/closed) |
| | Display of tire pressure |
| | Display of fuel consumption |
| | Display of fuel amount |
| | Maintenance reminder |
| Vehicle assistance | Roadside assistance |
| | Emergency rescue |
| | Automatic collision |
| | notification |
| | Query of vehicle location |
| | Immobilizer function |

In one embodiment, the ECU 200 may further include a positioning module (not shown) configured to transmit location information of the vehicle to the smart key 100 for display thereby. In one embodiment, the transceiver unit 10 may be capable of communication with an electronic device (e.g., a mobile phone), enabling the electronic device to display information intended to be displayed by the display unit 30 (e.g., information relating to the states of the engine, the air conditioner, driving information, vehicle location, etc.) via an application program on the electronic device. The application program may be designed to have functions as listed in Table 2, but this disclosure is not limited in this respect.

TABLE 2

| Category | Function |
|---|---|
| Remote control | Remote software update/ |
| | error correction |
| | Query of vehicle state |
| | Remote security |
| | Remote lighting control |
| | Remote buzzer control |
| | Window control (up/down) |
| | Remote engine control |
| | (start/shutdown) |
| | Atmosphere light control |
| | Remote headlight control |
| Vehicle diagnosis | Remote diagnosis |
| | Self diagnosis |
| | ECO driving report |
| | Display of door/hood/trunk |
| | state (opened/closed) |
| | Display of tire pressure |
| | Display of fuel consumption |
| | Display of fuel amount |
| Vehicle assistance | Roadside assistance |
| | Emergency rescue |
| | Automatic collision |
| | notification |
| | Query of vehicle location |
| | Immobilizer function |
| Driver information | Personal information |
| | Driving behavior analysis |
| | Maintenance record |
| | Q & A |
| Air conditioner information | Remote air conditioner control |
| | (on/off) |
| | Air volume display |
| | Temperature display |
| | Circulation indication |
| | Fan mode setting |
| | Power on/off indication |
| | Temperature unit setting |
| | Front defrost indication |
| | Rear defrost indication |
| | Seat heating control |

It is noted that control of the smart key 100 is not limited to touch control. In one embodiment, the smart key 100 may include a microphone unit 50 (see FIG. 1) that is coupled to the control unit 20 and that includes a microphone to convert sound received thereby into a voice signal in a form of an electric signal which is to be transmitted to the BCM 210 via the transceiver unit 10 and the transceiver module 201, so that the control unit 20 is able to control operation of the BCM 210 in response to the voice signal. In addition, the control unit 20 may analyze the voice signal, and cause the display unit 30 to display a voice message of the voice signal in a form of a text. Commands that may be executed via the voice control are exemplarily listed in Table 3.

TABLE 3

| Voice control command | Action |
|---|---|
| Lock | Lock the doors, and activate |
| | the security system |
| Unlock | Unlock the doors, and |
| | deactivate the security system |
| Trunk release | Release the trunk |
| Security information | Enter a page of “Security |
| | Information” (see FIG. 3) after |
| | the screen is unlocked |
| Vehicle information | Enter a page of “Vehicle |
| | Information” (see FIG. 4) after |
| | the screen is unlocked |
| Air conditioner presetting | Enter a page of “Air |
| | Conditioner Preset” (see FIG. |
| | 5) after the screen is unlocked |
| Setting | Enter a page of “Setting” (see |
| | FIG. 6) after the screen is |
| | unlocked |
| Registration | Enter a page of “Registration” |
| | (see FIG. 7) after the screen is |
| | unlocked |

In one embodiment, the smart key 100 may include a speaker unit 60 (see FIG. 1) coupled to the control unit 20, so that the control unit 20 is able to control the speaker unit 60 to audibly output the states or operations of the electronic devices controlled by the BCM 210. The messages which may be audibly output by the speaker unit 60 are exemplarily listed in Table 4.

TABLE 4

| Operation/state | Audible output |
|---|---|
| Lock | Report “Locked” after the |
| | doors are locked |
| Unlock | Report “Unlocked” after the |
| | doors are unlocked |
| Trunk release | Report “Trunk released” after |
| | the trunk is released |
| Security information | Report “Doors and windows |
| | are closed” or “Doors or |
| | windows are not properly |
| | closed, please check” after |
| | checking the states of the |
| | doors and the windows when |
| | the smart key is not in the |
| | vehicle |
| Low fuel | Report “Low fuel” |
| Air conditioner presetting | Report “Preset completed” or |
| | “Preset failed” after presetting |
| | operation |
| Registration | Report “Registration |
| | completed” or “Registration |
| | failed” after registration |
| | operation |

In summary, the smart electronic control system for a vehicle according to this disclosure allows user to use the smart key 100 to remotely control operation of the body control module 210 via communication between the transceiver unit 10 and the transceiver module 201, facilitating user operation.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A smart key adapted for use with a body control module (BCM) of an electronic control unit (ECU) for a vehicle, the BCM being configured to control electronic devices of the vehicle, said smart key comprising:
a transceiver unit configured to communicate with the ECU;
a control unit coupled to said transceiver unit; and
a display unit coupled to said control unit;
wherein said control unit is configured to establish connection with the ECU via communication between said transceiver unit and the ECU for controlling operation of the BCM, and to control said display unit to display a state of at least one of the electronic devices controlled by the BCM.

2. The smart key of claim 1, further comprising a button unit coupled to said control unit and operable by a user, wherein said control unit is further configured to control operation of the BCM of the ECU in response to triggering of said button unit.

3. The smart key of claim 2, wherein said button unit includes a trunk control button for releasing a trunk of the vehicle, a lock button for locking at least one door of the vehicle, an unlock button for unlocking at least one door of the vehicle, and a power button for switching said smart key between a power-on state and a power-off state.

4. The smart key of claim 1, wherein said display unit includes a touch screen, and said control unit is configured to control operation of the BCM in response to a touch operation on said touch screen.

5. The smart key of claim 1, further comprising a microphone unit that is coupled to said control unit and that includes a microphone to convert sound received thereby into a voice signal in a form of an electric signal, wherein said control unit is configured to control operation of the BCM in response to the voice signal.

6. The smart key of claim 1, further comprising a speaker unit coupled to said control unit, wherein said control unit is configured to control said speaker unit to audibly output the state of said at least one of the electronic devices controlled by said BCM.

7. A smart electronic control system for a vehicle, comprising:
an electronic control unit (ECU) to be disposed on the vehicle and including a body control module (BCM) configured to control electronic devices of the vehicle; and
a smart key including:
a transceiver unit configured to communicate with said ECU;
a control unit coupled to said transceiver unit; and
a display unit coupled to said control unit;
wherein said control unit is configured to establish connection with said ECU via communication between said transceiver unit and said ECU for controlling operation of said BCM, and to control said display unit to display a state of at least one of the electronic devices controlled by said BCM.

8. The smart electronic control system of claim 7, further comprising a button unit coupled to said control unit and operable by a user, wherein said control unit is further configured to control operation of said BCM of said ECU in response to triggering of said button unit.

9. The smart electronic control system of claim 8, wherein said button unit includes a trunk control button for releasing a trunk of the vehicle, a lock button for locking at least one door of the vehicle, an unlock button for unlocking at least one door of the vehicle, and a power button for switching said smart key between a power-on state and a power-off state.

10. The smart electronic control system of claim 7, wherein said display unit includes a touch screen, and said control unit is configured to control operation of said BCM in response to a touch operation on said touch screen.

11. The smart electronic control system of claim 7, wherein said ECU further includes a transceiver module coupled to said BCM and configured for communication with said transceiver unit of said smart key; and
wherein said BCM includes
a door control module coupled to said transceiver module and configured to switch at least a door of the vehicle between a locked state and an unlocked state; and
a window control module coupled to said transceiver module and configured to control operation of at least a window of the vehicle;
wherein said control unit controls operation of at least one of said door control module or said window control module via communication between said transceiver unit and said transceiver module, and controls said display unit to display a result relating to the operation of said at least one of said door control module or said window control module.

12. The smart electronic control system of claim 11, wherein said BCM further includes:
an engine control module coupled to said transceiver module and configured to control operation of an engine of the vehicle;
an air conditioner control module coupled to said transceiver module and configured to control operation of an air conditioner of the vehicle;
a fuel control module coupled to said transceiver module and configured to control operation of a fuel gauge of the vehicle; and
a light control module coupled to said transceiver module and configured to control light of the vehicle;
wherein said control unit controls operation of at least one of said engine control module, said air conditioner control module, said fuel control module, or said light control module via communication between said transceiver unit and said transceiver module, and controls said display unit to display a result relating to the operation of said at least one of said engine control module, said air conditioner control module, said fuel control module, or said light control module.

13. The smart electronic control system of claim 7, further comprising a microphone unit that is coupled to said control unit and that includes a microphone to convert sound received thereby into a voice signal in a form of an electric signal, wherein said control unit is configured to control operation of said BMC in response to the voice signal.

14. The smart electronic control system of claim 7, further comprising a speaker unit coupled to said control unit, wherein said control unit is configured to control said speaker unit to audibly output the state of said at least one of the electronic devices controlled by said BCM.
